(19) United States
(12) Patent Application Publication
(10) Pub. No.: US 2024/0372490 A1
(43) Pub. Date: Nov. 7, 2024

(54) VARIABLE FREQUENCY PULSED ELECTRIC MACHINE CONTROL SYSTEM

(71) Applicant: BorgWarner Inc., Auburn Hills, MI (US)

(72) Inventor: Prashant Ramakrishna HEGDE, Stuttgart (DE)

(21) Appl. No.: 18/649,296

(22) Filed: Apr. 29, 2024

Related U.S. Application Data
(60) Provisional application No. 63/464,001, filed on May 4, 2023.

(51) Int. Cl. H02P 6/15; B60L 15/20

(52) U.S. Cl. CPC H02P 6/153; B60L 15/20

(57) ABSTRACT

A method of controlling a rotating electrical machine includes the steps of generating a continuously time varying torque command, configured to command the rotating electrical machine to reach an angular velocity; converting the continuously time varying torque command to a dynamic frequency pulsed torque command having a dynamic torque value; and providing the dynamic frequency pulsed torque command to the rotating electrical machine at a varying frequency.

### CROSS-REFERENCE TO RELATED APPLICATIONS

This application claims priority pursuant to 35 U.S.C. 119 (a) to U.S. Application No. 63/464,001, filed May 4, 2023, which application is incorporated herein by reference in its entirety.

### FIELD OF THE INVENTION

The present disclosure relates to control systems and, more particularly, control systems that control rotating electrical machines.

### BACKGROUND

Control systems that regulate operation of rotating electrical machines can generate torque commands used to vary the speed and torque of the rotating electrical machines depending on an operating environment. However, the control system regulating the rotating electrical machines may not be particularly efficient at a particular angular speed or torque of an output shaft. It would be helpful to increase the efficiency of the rotating electrical machine by altering the control system such that the control system regulates the flow of electrical current in a way that more efficiently operates the rotating electrical machine at a particular torque/speed level.

### SUMMARY

In one embodiment, a method of controlling a rotating electrical machine includes the steps of generating a continuously time varying torque command, configured to command the rotating electrical machine to reach an angular velocity; converting the continuously time varying torque command to a dynamic frequency pulsed torque command having a dynamic torque value; and providing the dynamic frequency pulsed torque command to the rotating electrical machine at a varying frequency.

In another embodiment, a method of controlling a rotating electrical machine includes the steps of generating a continuously time varying torque command, configured to command the rotating electrical machine to reach an angular velocity; converting the continuously time varying torque command to a dynamic frequency pulsed torque command having a dynamic torque value; determining whether the dynamic frequency pulsed torque command reduces energy loss relative to the continuously time varying torque command; and providing the dynamic frequency pulsed torque command to the rotating electrical machine at a varying frequency if the dynamic frequency pulsed torque command reduces energy loss relative to the continuously time varying torque command.

In yet another embodiment, an electric vehicle including a rotating electrical machine that wholly, or at least partially, propels the electric vehicle, includes a control system, having one or more microprocessors, configured to electrically couple to a vehicle battery and the rotating electrical machine, such that the control system generates a continuously time varying torque command, configured to command the rotating electrical machine to reach an angular velocity; converts the continuously time varying torque command to a dynamic frequency pulsed torque command having a dynamic torque value; and provides the dynamic frequency pulsed torque command to the rotating electrical machine at a varying frequency.

### BRIEF DESCRIPTION OF THE DRAWINGS

FIG. 1 is a block diagram depicting an implementation of an electric vehicle including a control system;

FIG. 2 is a flow chart depicting an implementation of a method of generating a pulsed torque command for a rotating electrical machine; and

FIG. 3 includes graphs depicting an implementation of generating a pulsed torque command for a rotating electrical machine a method of generating a pulsed torque command for a rotating electrical machine;

FIG. 4 includes a table depicting an implementation of a method of generating a pulsed torque command for a rotating electrical machine;

FIG. 5 includes graphs depicting an implementation of a method of generating a pulsed torque command for a rotating electrical machine;

FIG. 6 includes graphs depicting an implementation of a method of generating a pulsed torque command for a rotating electrical machine;

FIG. 7 includes a graph depicting an implementation of a method of generating a pulsed torque command for a rotating electrical machine; and

FIG. 8 includes a graph depicting an implementation of a method of generating a pulsed torque command.

### DETAILED DESCRIPTION

A control system can generate a pulsed torque command for a rotating electrical machine in an electric vehicle at a dynamic frequency based on the energy output of the rotating electrical machine resulting from the command using the dynamic frequency compared to the energy output resulting from a continuously time varying command. The control system can generate a continuously time varying torque command capable of commanding the rotating electrical machine to reach an angular velocity or speed. The continuously time varying torque command can include a torque value and the control system can determine a quantity of energy or torque output by the rotating electrical machine at the torque value based on the torque command over a measured quantity of time. The control system can use the energy output by the rotating electrical machine based on the continuously time varying torque command to generate a dynamic frequency pulsed torque command having a dynamic torque value. Given the dynamic torque value, the control system can determine a quantity of energy or torque output by the rotating electrical machine at the dynamic torque value based on the pulsed torque command over a measured quantity of time.

The frequency and/or on/off state of the pulsed torque command can be controlled by the quantity of energy or torque output by the rotating electrical machine at the continuously time varying torque command relative to a quantity of energy or torque output by the rotating electrical machine at the pulsed torque value over a measured quantity of time. The control system can compare the relative energy amounts and, when one becomes less than or greater than the other, a change in state for the pulsed torque command can occur. Given this arrangement, the frequency of the pulsed torque command is variable and not dependent on a fixed frequency value. That is, the pulsed command does not have a fixed frequency.

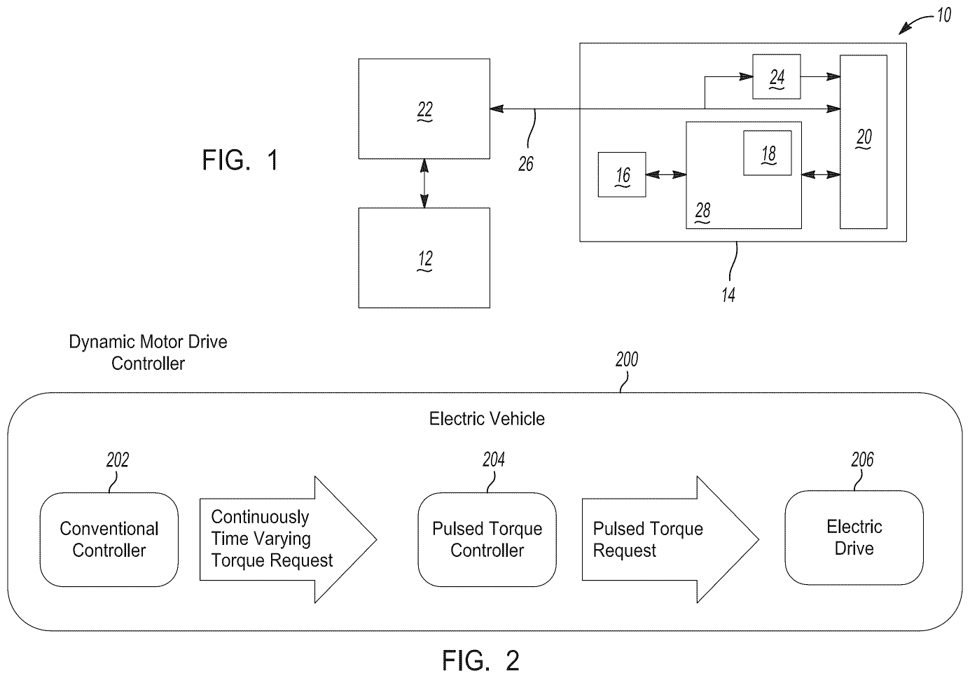

Turning to FIG. 1, an implementation of an electrical system 10 is shown including an electrical grid 12 and an electric vehicle (EV) 14 that can either receive electrical power from or provide electrical power to the grid 12. The electrical grid 12 can include any one of a number of electrical power generators and electrical delivery mechanisms. The EV 14 can include a rotating electrical machine 16 (also referred to as an electric motor) that wholly, or at least partially, propels the EV 14. In one implementation, the rotating electrical machine 16 can be an Electrically-Excited Synchronous Motor (EESM), but other implementations are possible using the controller and functionality described herein. A three-phase inverter 18 can be electrically coupled to an EV battery 20 and the rotating electrical machine 16. The inverter can receive DC electrical power from the EV battery 20 and invert the DC electrical power into three-phase AC electrical power before supplying the AC electrical power to the rotating electrical machine 16. The amount of voltage supplied by the EV battery to the rotating electrical machine can vary by application. The term “electric vehicle” or “EV” can refer to vehicles that are propelled, either wholly or partially, by rotating electrical machines. EV can refer to electric vehicles, plug-in electric vehicles, hybrid-electric vehicles, and battery-powered vehicles.

The EV battery 20 can supply DC electrical power controlled by power electronics included in the inverter 18 to the rotating electrical machine 16 that propels the EV 14. The EV battery 20 or batteries are rechargeable. Examples of the battery include lead-acid batteries, nickel cadmium (NiCd), nickel metal hydride, lithium-ion, and lithium polymer batteries. An on-board charger 24 can supply charge to the EV battery 20 and an electrical cable 26 can connect the EV to the grid 12. A control system 28, implemented as computer-readable instructions executable by the microprocessor, can be stored in non-volatile memory and called on to monitor vehicle sensors and generate control signals that include a torque command for the rotating electrical machine 16 of the EV 14. This will be discussed in more detail below.

FIG. 2 depicts a method 200 of generating a pulsed torque command for a rotating electrical machine in an electric vehicle at a dynamic frequency based on a conventional energy output of the rotating electrical machine compared to the energy output as a result of the pulsed torque command. The method 200 begins by generating a continuously time varying torque command capable of commanding the rotating electrical machine to reach an angular velocity or speed at block 202. The continuously time varying torque command can be converted to a dynamic frequency pulsed torque command having a dynamic torque value at block 204. The dynamic frequency pulsed torque command can be provided to the rotating electrical machine 16 at block 206.

Generally speaking, the dynamic frequency pulsed torque command can be created by defining dynamic control parameters, generating a continuously time varying torque command capable of commanding the rotating electrical machine, determining a torque for most efficient operation given a particular rotating electrical machine and inverter, calculating an equivalent dynamic frequency pulsed torque command based on the continuously time varying torque command, ensuring use of the dynamic frequency pulsed torque command reduces energy loss (otherwise, use the continuously time varying torque command), and calculating the rotating electrical machine and inverter losses for both continuously time varying and dynamic pulsed operation; compare the results.

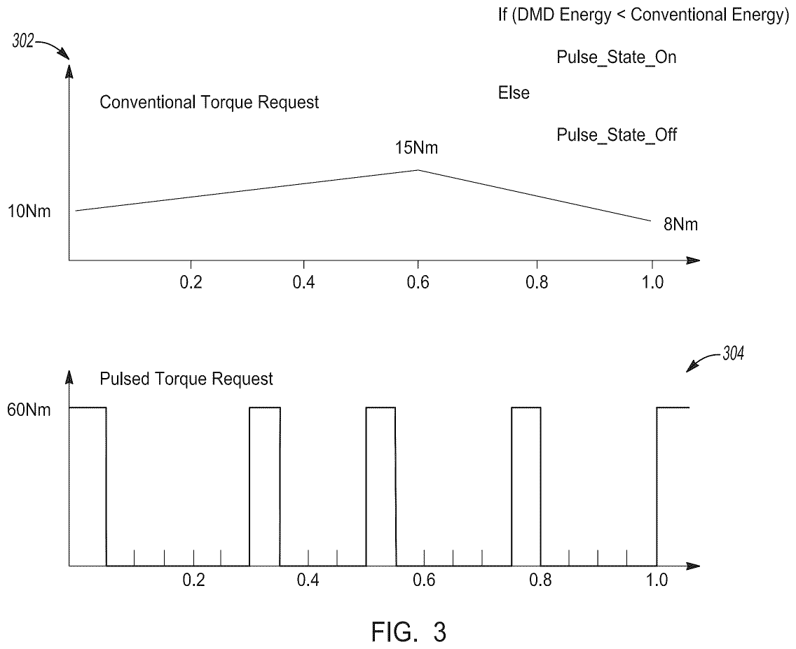

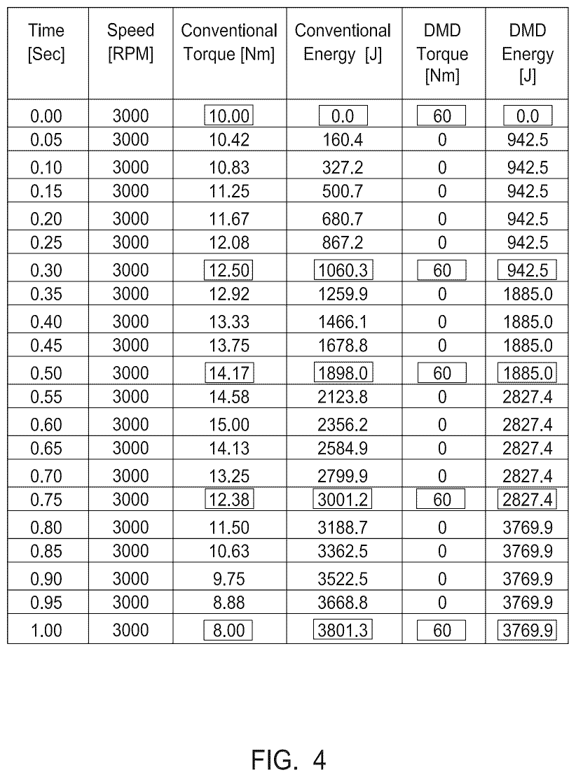

FIG. 3 includes a graph 302 depicting an implementation of a continuously time varying torque command over time compared to a graph 304 depicting an implementation of a dynamic frequency pulsed torque command over time. Graph 302 reflects the continuously time varying torque command originally at 10 Nm, rising to 15 Nm at 0.6 seconds, and falling to 8 Nm at 1.0 seconds. As can be appreciated in graph 304, the dynamic frequency pulsed torque command rises and falls at a variable frequency. The frequency can be controlled by the algorithm discussed above, which may be implemented as shown in a table included as FIG. 4.

The table includes columns for time, angular speed of the rotating electrical machine 16, torque (Nm) output based on the continuously time varying torque command, mechanical energy output by the rotating electrical machine 16 (J) using the continuously time varying torque command, the dynamic frequency pulsed torque command (DMD) (Nm), and the mechanical energy output by the rotating electrical machine 16 using the dynamic frequency pulsed torque command (DMD Energy). In this example, at time zero, the dynamic frequency pulsed torque command is 60 Nm (assumed to be the torque for which combined rotating electrical machine and inverter efficiency is maximum at a given motor speed) and the continuously time varying torque command begins at 10 Nm. At 0.05 seconds, the energy output using the dynamic frequency pulsed torque command is 942.5 J and the energy output using the continuously time varying torque command is 160.5 J. The control system 28 can determine that the energy output using the dynamic frequency pulsed torque command becomes greater than the energy output using the continuously time varying torque command and then end the dynamic frequency pulsed torque command.

As time passes, the energy output using the continuously time varying torque command rises and the dynamic frequency pulsed torque command remains at 942.5 J given that the dynamic frequency pulsed torque command is low (zero). Once the energy output using the continuously time varying torque command rises to 1060.3 J, above 942.5 J, at 0.3 seconds, the control system 28 can activate the dynamic frequency pulsed torque command again at 60 Nm. More time can pass and the control system 28 measures the energy output using the continuously time varying torque command as it continues to rise and the dynamic frequency pulsed torque command as it continues to rise given that the dynamic frequency pulsed torque command is at 60 Nm. At 0.35 seconds, the energy output using the dynamic frequency pulsed torque command is 1885.0 J and the energy output using the continuously time varying torque command is 1259.9 J. The control system 28 can determine, at 0.35 seconds, that the energy output using the dynamic frequency pulsed torque command became greater the energy output using the continuously time varying torque command and can end the dynamic frequency pulsed torque command. This determination can repeat at 0.50 seconds, 0.75 seconds, and 1.0 second as appreciated in the table. A control parameter can be defined to determine the minimum time duration for pulse on state and pulse off state.

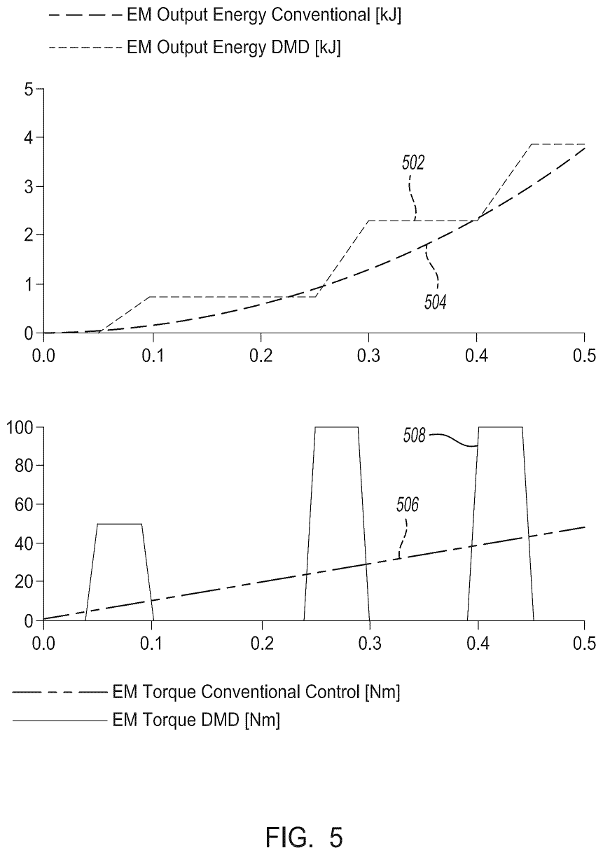

FIG. 5 depicts a graphical representation of the energy output using the dynamic frequency pulsed torque command 502, the energy output using the continuously time varying torque command 504, the continuously time varying torque command 506, and the dynamic frequency pulsed torque command 508. FIG. 5 also depicts a portion of the continuously time varying torque command 506, and the dynamic frequency pulsed torque command along with a set of control system parameters (DMD control parameters) for controlling the dynamic frequency pulsed torque command 508. An implementation of the continuously time varying torque command 506 and the dynamic frequency pulsed torque command 508 are also shown in FIG. 8. The control system parameters include a TimeStep establishing the time increments for making calculations, EM_SlewRate establishing the rate or slope at which the actual rotating electrical machine torque changes, DMD_Frequency in hertz used to calculate a minimum duration of state, DMD_Spd_Min establishing a rotating electrical machine angular velocity below which the algorithm is not used, DMD_Vel_Min establishing an EV speed below which the algorithm is not used, DMD_Spd_Max establishing a rotating electrical machine angular velocity above which the algorithm is not used, DMD_TrqRatio_Max establishing a maximum torque ratio between the dynamic frequency pulsed torque command and the continuously time varying torque command, DMD_Tolerance establishing the percent reduction in loss between dynamic frequency pulsed torque commands and continuously time varying torque command, DMD_Trq_Min establishing a minimum torque below which the algorithm is not used, and DMD_ControlFlag providing an approach that permits zero torque control or inverter off control.

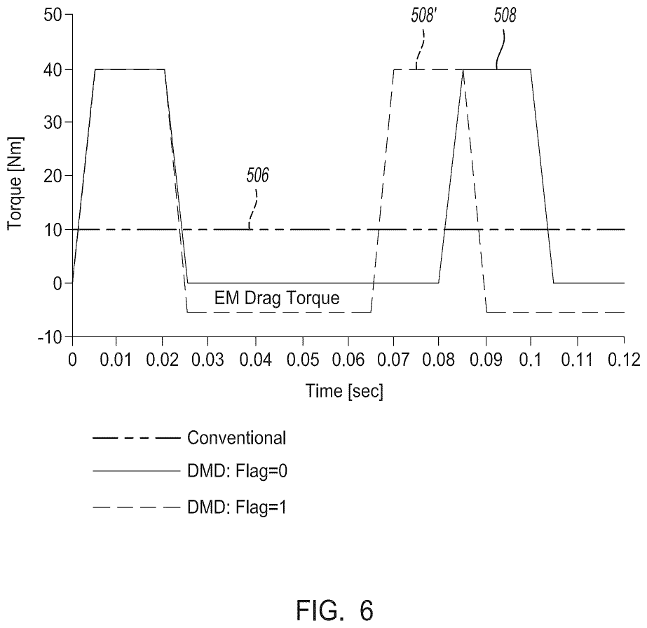

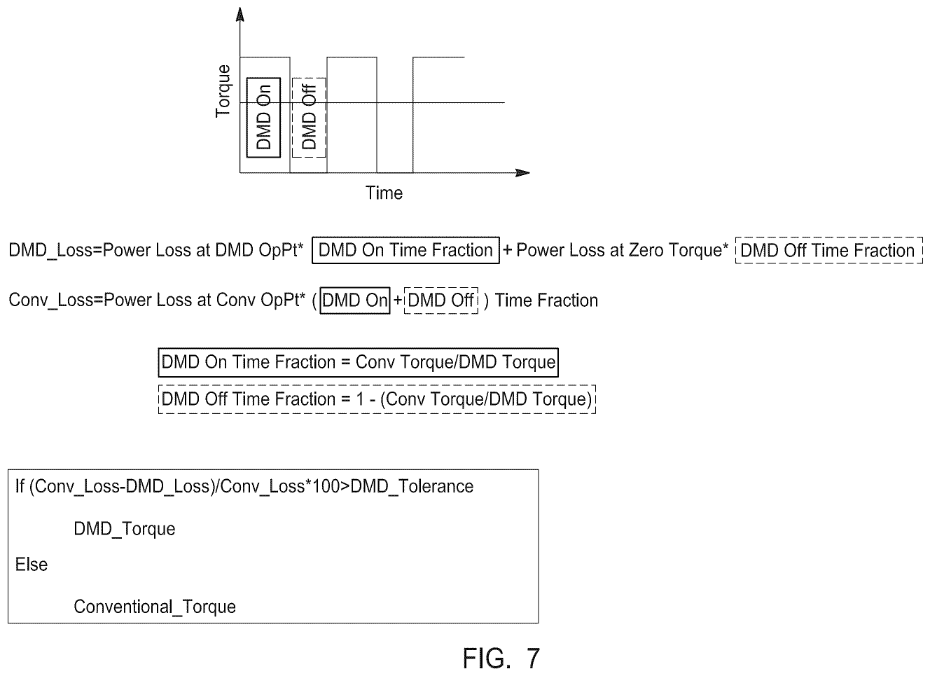

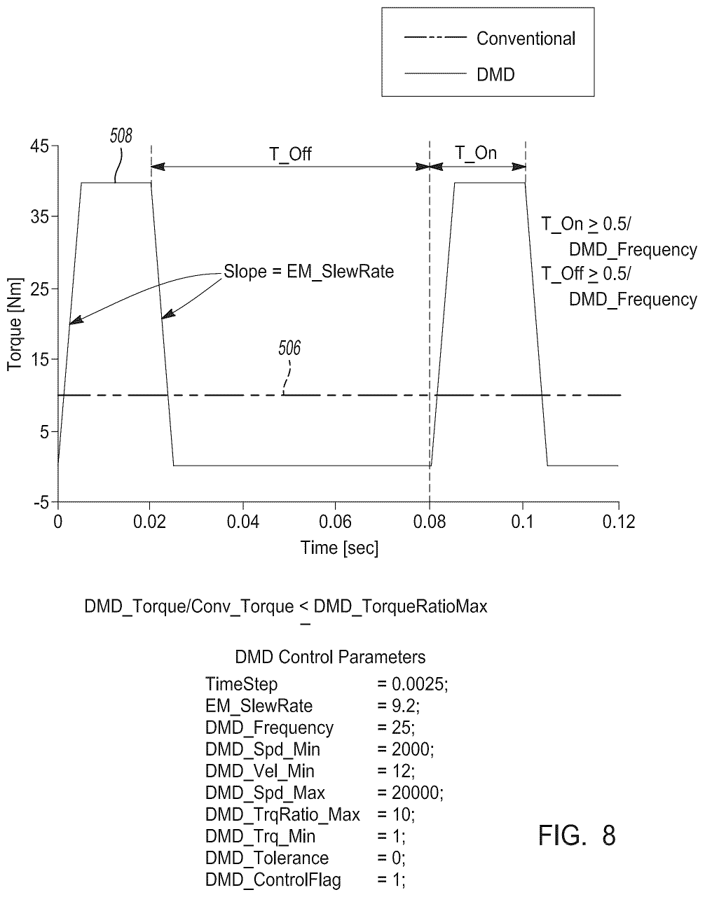

FIG. 6 depicts the DMD_ControlFlag setting in more detail. For example, a graph depicts the continuously time varying torque command 506, the dynamic frequency pulsed torque command 508 with the control flag set to logical zero, and the dynamic frequency pulsed torque command 508′ with the control flag set to logical one. When the control flag is set to logical zero, the control system 28 requests zero torque from the rotating electrical machine 16 during pulse off state, whereas when the control flag is set to one, the control system 28 turns the inverter off completely during pulse off state causing drag (negative torque output) due to mechanical losses. FIG. 7 describes the logic to ensure the dynamic frequency pulsed torque control results in lower rotating electrical machine and inverter loss in comparison to continuously time varying torque control.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of controlling a rotating electrical machine, comprising the steps of:
(a) generating a continuously time varying torque command, configured to command the rotating electrical machine to reach an angular velocity;
(b) converting the continuously time varying torque command to a dynamic frequency pulsed torque command having a dynamic torque value; and
(c) providing the dynamic frequency pulsed torque command to the rotating electrical machine at a varying frequency.

2. The method recited in claim 1, further comprising the step of selecting a pulse state of the dynamic frequency pulsed torque command based on an energy output of the rotating electrical machine resulting from the dynamic frequency pulsed torque command compared to an energy output resulting from a continuously time varying command.

3. The method recited in claim 1, further comprising the step of including a torque value with the continuously time varying torque command.

4. The method recited in claim 1, further comprising the steps of determining a quantity of energy or torque output by the rotating electrical machine at a commanded torque value over a quantity of time using the continuously time varying torque command; and generating the dynamic frequency pulsed torque command having a dynamic torque value based on the determined quantity of energy or torque output.

5. The method recited in claim 4, further comprising the step of determining a quantity of energy or torque output by the rotating electrical machine based on the dynamic frequency pulsed torque command over a measured quantity of time and comparing it to the quantity of energy or torque output determined using the continuously time varying torque value.

6. The method recited in claim 1, further comprising the steps of establishing the varying frequency of the pulsed torque command using a quantity of energy or torque output by the rotating electrical machine at the continuously time varying torque command relative to a quantity of energy or torque output by the rotating electrical machine at the dynamic frequency pulsed torque command over a measured quantity of time; comparing the quantities; and, when one becomes less than or greater than the other, changing a state of the pulsed torque command.

7. The method recited in claim 1, wherein the rotating electrical machine is installed in an electric vehicle.

8. A method of controlling a rotating electrical machine, comprising the steps of:
(a) generating a continuously time varying torque command, configured to command the rotating electrical machine to reach an angular velocity;
(b) converting the continuously time varying torque command to a dynamic frequency pulsed torque command having a dynamic torque value;
(c) determining whether the dynamic frequency pulsed torque command reduces energy loss relative to the continuously time varying torque command; and
(d) providing the dynamic frequency pulsed torque command to the rotating electrical machine at a varying frequency if the dynamic frequency pulsed torque command reduces energy loss relative to the continuously time varying torque command.

9. The method recited in claim 8, further comprising the step of selecting a pulse state of the dynamic frequency pulsed torque command based on an energy output of the rotating electrical machine resulting from the dynamic frequency pulsed torque command compared to an energy output resulting from a continuously time varying command.

10. The method recited in claim 8, further comprising the step of including a torque value with the continuously time varying torque command.

11. The method recited in claim 8, further comprising the steps of determining a quantity of energy or torque output by the rotating electrical machine at a commanded torque value over a quantity of time using the continuously time varying torque command; and generating the dynamic frequency pulsed torque command having a dynamic torque value based on the determined quantity of energy or torque output.

12. The method recited in claim 11, further comprising the step of determining a quantity of energy or torque output by the rotating electrical machine based on the dynamic frequency pulsed torque command over a measured quantity of time and comparing it to the quantity of energy or torque output determined using the continuously time varying torque value.

13. The method recited in claim 8, further comprising the steps of establishing the varying frequency of the pulsed torque command using a quantity of energy or torque output by the rotating electrical machine at the continuously time varying torque command relative to a quantity of energy or torque output by the rotating electrical machine at the dynamic frequency pulsed torque command over a measured quantity of time; comparing the quantities; and, when one becomes less than or greater than the other, changing a state of the pulsed torque command.

14. The method recited in claim 8, wherein the rotating electrical machine is installed in an electric vehicle.

15. An electric vehicle including a rotating electrical machine that wholly, or at least partially, propels the electric vehicle, comprising:
a control system, including one or more microprocessors, configured to electrically couple to a vehicle battery and the rotating electrical machine, wherein the control system generates a continuously time varying torque command, configured to command the rotating electrical machine to reach an angular velocity; converts the continuously time varying torque command to a dynamic frequency pulsed torque command having a dynamic torque value; and provides the dynamic frequency pulsed torque command to the rotating electrical machine at a varying frequency.
